(19) United States
(12) Patent Application Publication
(10) Pub. No.: US 2016/0124535 A1
(43) Pub. Date: May 5, 2016

(54) METHOD OF CHARACTER IDENTIFICATION THAT USES BUTTON PRESS TYPES

(71) Applicant: Michael William Murphy, Bellingham, WA (US)

(72) Inventor: Michael William Murphy, Bellingham, WA (US)

(21) Appl. No.: 14/701,417

(22) Filed: Apr. 30, 2015

Related U.S. Application Data
(60) Provisional application No. 62/074,587, filed on Nov. 3, 2014.

(51) Int. Cl. G06F 3/041

(52) U.S. Cl. CPC G06F 3/041; G06F 2203/04104

(57) ABSTRACT

Systems, devices and methods are disclosed for input of characters and text using button press types. A device identifies button presses as one of three types that are both mutually exclusive and that categorize all possible button press outcomes. For all three types, a selection button press tentatively identifies a first character and initiates the elapsed time period. For a ‘short’ button press the user ends the button press before the time period expires. For a ‘long’ button press the user maintains the button press until after the time period expires. For a ‘pair’ button press the user presses an additional selection button before the time period expires. The elapsed time period ends once the second button press occurs. The button press type together with an assigned value(s) of the pressed button(s) identifies a particular character for selection.

### BACKGROUND

### Technical Field

This description generally relates to the field of electronic devices and, more particularly, to user interfaces of electronic devices.

### BRIEF SUMMARY

A computer processor-implemented method may be summarized as including: detecting, by at least one computer processor, onset of a first button press of a button of a plurality of buttons; interpreting, by at least one computer processor, between first, second and third button press types based on button presses that occur during a finite-length time period measured from the onset of the first button press, the interpreting including: interpreting, by at least one computer processor, between the first and second button press types based on whether the duration of the first button press exceeds a length of the finite-length time period, and interpreting, by at least one computer processor, the third button press type instead of the first and second button press type if at least one processor detects occurrence of a second button press of a button of the plurality of buttons during the finite-length time period.

Each button of the plurality of buttons may have a button press value and may further include determining, by at least one computer processor, a total button press value based on the interpreting between the first, second and third button press types.

The computer processor-implemented method may further include identifying a character from among a plurality of characters based on the determined total button press value. The character may be identified by a position in a one-dimensional array corresponding to the determined total button press value.

The computer processor-implemented method may further include, if the first button press type is interpreted, the at least one computer processor determines the total button press value to be equal to the button press value of the button of the first button press.

The computer processor-implemented method may further include, if the second button press type is interpreted, the at least one computer processor determines the total button press value to be equal to a multiple of the button press value of the button of the first button press.

The total button press value may equal two times the button press value of the button of the first button press.

The computer processor-implemented method may further include, if the third button press type is interpreted, the at least one computer processor determines the total button press value to be equal to the sum of the button press value of the button of the first button press and the button press value of the button of the second button press.

The length of the finite-length time period may be selectable by a user. The length of the finite-length time period may be between 0.05 and 0.2 seconds.

A system may be summarized as including: at least one computer processor; and at least one memory coupled to the at least one computer processor, the at least one memory having computer executable instructions stored thereon that, when executed, cause the at least one processor to perform: detecting onset of a first button press of a button of a plurality of buttons; interpreting between first, second and third button press types based on button presses that occur during a finite-length time period measured from the onset of the first button press, the interpreting including: interpreting between the first and second button press types based on whether the duration of the first button press exceeds a length of the finite-length time period, and interpreting the third button press type instead of the first and second button press type if at least one processor detects occurrence of a second button press of a button of the plurality of buttons during the finite-length time period.

Each button of the plurality of buttons may have a button press value and may further include determining, by at least one computer processor, a total button press value based on the interpreting between the first, second and third button press types. The computer executable instructions, when executed, may further cause the at least one processor to perform identifying a character from among a plurality of characters based on the determined total button press value. The character may be identified by a position in a one-dimensional array corresponding to the determined total button press value. The computer executable instructions, when executed, may further cause the at least one processor to perform, if the first button press type is interpreted, determining the total button press value to be equal to the button press value of the button of the first button press.

A non-transitory computer-readable medium may be summarized as having computer executable instructions stored thereon that, when executed, cause at least one processor to perform: detecting onset of a first button press of a button of a plurality of buttons; interpreting between first, second and third button press types based on button presses that occur during a finite-length time period measured from the onset of the first button press, the interpreting including: interpreting between the first and second button press types based on whether the duration of the first button press exceeds a length of the finite-length time period, and interpreting the third button press type instead of the first and second button press type if at least one processor detects occurrence of a second button press of a button of the plurality of buttons during the finite-length time period.

Each button of the plurality of buttons may have a button press value and may further include determining, by at least one computer processor, a total button press value based on the interpreting between the first, second and third button press types. The computer executable instructions, when executed, may further cause the at least one processor to perform identifying a character from among a plurality of characters based on the determined total button press value. The character may be identified by a position in a one-dimensional array corresponding to the determined total button press value. The computer executable instructions, when executed, may further cause the at least one processor to perform, if the first button press type is interpreted, determining the total button press value to be equal to the button press value of the button of the first button press.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a schematic view of an example electronic device for input of characters with optional time-dependent button presses according to one illustrated embodiment, the electronic device being a mobile device having a housing, a display, a graphics engine, a central processing unit (CPU), user input device(s), one or more storage mediums having various software modules thereon that are executable by the CPU, input/output (I/O) port(s), network interface(s), wireless receiver(s) and transmitter(s), a power source, an elapsed time counter and a button press value counter.

FIG. 2 is a schematic drawing of one embodiment of the electronic device for input of characters. FIG. 3 is a flow diagram that shows a method for specifying a character from among a plurality of characters according to one illustrated embodiment.

FIG. 4 is a flow diagram that shows a method for an electronic device to interpret button presses according to one illustrated embodiment.

FIG. 5 is a flow diagram that shows one part of the flow diagram of FIG. 4.

FIG. 6 is graphical representations of various button press types.

FIG. 7 is a table of value assignments, a user interface and a list of variables for one embodiment of a method of character identification.

FIG. 8 is flow diagrams that show variables and values for an embodiment of a method for an electronic device to interpret button presses.

FIG. 9 is an example of an application of a method of character identification.

FIG. 10 is another example of an application of a method of character identification.

FIG. 11 is a flow diagram that shows a method for an electronic device to interpret button presses according to one illustrated embodiment.

FIG. 12 is a flow diagram that shows another method for an electronic device to interpret button presses according to one illustrated embodiment.

FIG. 13 is flow diagrams that show variables and values for an embodiment of a method for an electronic device to interpret button presses.

FIG. 14 is examples of an application of a method of character identification.

FIG. 15 is a flow diagram that shows variables of two methods for an electronic device to interpret button presses.

FIG. 16 is a table that compares characteristics of two methods for an electronic device to interpret button presses.

FIG. 17 is a schematic drawing of another embodiment of the electronic device 100 for input of characters.

FIG. 18 is a table of value assignments for another embodiment of a method of character identification.

FIG. 19 is a schematic drawing of yet another embodiment of the electronic device 100 for input of characters.

FIG. 20 is a table of value assignments for yet another embodiment of a method of character identification.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks, including various types of telecommunications networks, have not been shown or described in detail to avoid unnecessarily obscuring descriptions of the embodiments.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

Various embodiments are described herein that provide systems, devices and methods for input of characters with optional time-dependent button presses.

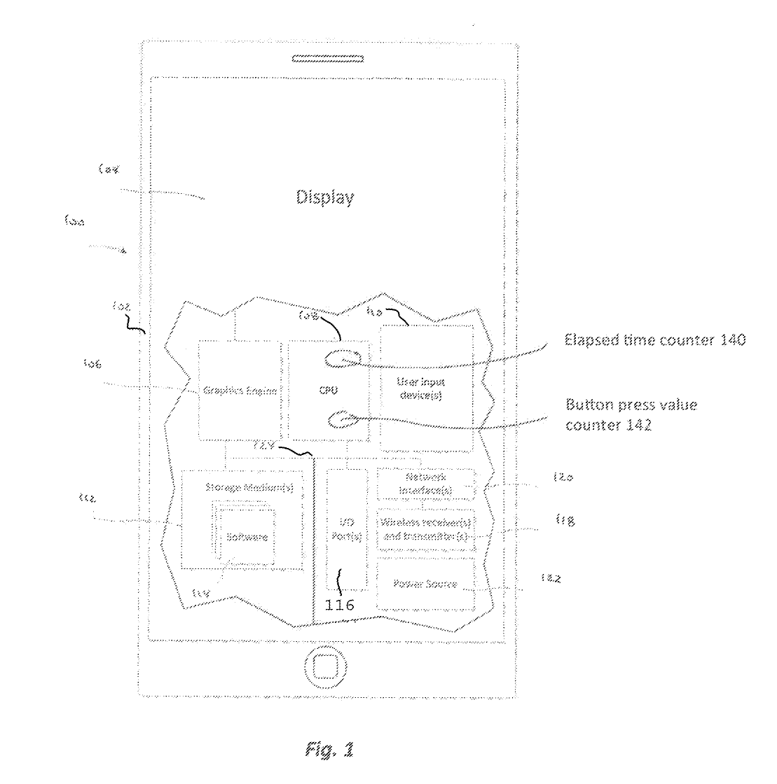

For example, FIG. 1 is a schematic view of one example electronic device, in this case mobile device 100, for input of characters with optional time-dependent button presses according to one illustrated embodiment. The mobile device 100 shown in FIG. 1 may have a housing 102, a display 104, a graphics engine 106, a central processing unit (CPU) 108, one or more user input devices 110, one or more storage mediums 112 having various software modules 114 stored thereon comprising instructions that are executable by the CPU 108, input/output (I/O) port(s) 116, one or more wireless receivers and transmitters 118, one or more network interfaces 120, and a power source 122. In some embodiments, some or all of the same, similar or equivalent structure and functionality of the mobile device 100 shown in FIG. 1 and described herein may be that of, part of or operably connected to a communication and/or computing system of another device or machine.

The mobile device 100 may be any of a large variety of communications devices such as a cellular telephone, a smartphone, a wearable device, a wristwatch, a portable media player (PMP), a personal digital assistant (PDA), a mobile communications device, a portable computer with built-in or add-on cellular communications, a portable game console, a global positioning system (GPS), a handheld industrial electronic device, or the like, or any combination thereof. The mobile device 100 has at least one central processing unit (CPU) 108 which may be a scalar processor, a digital signal processor (DSP), a reduced instruction set (RISC) processor, or any other suitable processor. The central processing unit (CPU) 108, display 104, graphics engine 106, one or more user input devices 110, one or more storage mediums 112, input/output (I/O) port(s) 116, one or more wireless receivers and transmitters 118, and one or more network interfaces 120 may all be communicatively connected to each other via a system bus 124. The system bus 124 can employ any suitable bus structures or architectures, including a memory bus with memory controller, a peripheral bus, and/or a local bus.

The mobile device 100 also includes one or more volatile and/or non-volatile storage medium(s) 112. The storage mediums 112 may be comprised of any single or suitable combination of various types of processor-readable storage media and may store instructions and data acted on by CPU 108. For example, a particular collection of software instructions comprising software 114 and/or firmware instructions comprising firmware are executed by CPU 108. The software or firmware instructions generally control many of the operations of the mobile device 100 and a subset of the software and/or firmware instructions may perform functions to operatively configure hardware and other software in the mobile device 100 to provide the initiation, control and maintenance of applicable computer network and telecommunication links from the mobile device 100 to other devices using the wireless receiver(s) and transmitter(s) 118, network interface(s) 120, and/or I/O ports 116.

The CPU 108 includes an elapsed time counter 140. The elapsed time counter 140 may be implemented using a timer circuit operably connected to or as part of the CPU 108. Alternately some or all of the elapsed time counter 140 may be implemented in computer software as computer executable instructions stored on volatile and/or non-volatile storage medium(s) 112, for example, that when executed by CPU 108 or a processor of a timer circuit, performs the functions described herein of the elapsed time counter 140.

The CPU 108 includes a button press value counter 142. Alternately, some or all of the button press value counter 142 may be implemented in computer software as computer executable instructions stored on volatile and/or non-volatile storage medium(s) 112, for example, that when executed by CPU 108, performs the functions described herein of the button press value counter 142.

By way of example, and not limitation, the storage medium(s) 112 may be processor-readable storage media which may comprise any combination of computer storage media including volatile and nonvolatile, removable and non-removable media implemented in any method or technology for storage of information such as computer readable instructions, data structures, program modules or other data. Combinations of any of the above should also be included within the scope of processor-readable storage media.

The storage medium(s) 112 may include system memory which includes computer storage media in the form of volatile and/or nonvolatile memory such as read-only memory (ROM) and random access memory (RAM). A basic input/output system (BIOS), containing the basic routines that help to transfer information between elements within mobile device 100, such as during start-up or power-on, is typically stored in ROM. RAM typically contains data and/or program modules that are immediately accessible to and/or presently being operated on by CPU 108. By way of example, and not limitation, FIG. 1 illustrates software modules 114 including an operating system, application programs and other program modules that implement the processes and methods described herein.

The mobile device 100 may also include other removable/non-removable, volatile/nonvolatile computer storage media drives. By way of example only, the storage medium(s) 112 may include a hard disk drive or solid state storage drive that reads from or writes to non-removable, nonvolatile media, an SSD that reads from or writes to a removable, nonvolatile SSD, and/or an optical disk drive that reads from or writes to a removable, nonvolatile optical disk such as a DVD-RW or other optical media. Other removable/non-removable, volatile/nonvolatile computer storage media that can be used in an operating environment of the mobile device 100 include, but are not limited to, flash memory cards, other types of digital versatile disks (DVDs), micro-discs, digital video tape, solid state RAM, solid state ROM, and the like. The storage medium(s) are typically connected to the system bus 124 through a non-removable memory interface. The storage medium(s) 112 discussed above and illustrated in FIG. 1 provide storage of computer readable instructions, data structures, program modules and other data for the mobile device 100. In FIG. 1, for example, a storage medium may store software 114 including an operating system, application programs, other program modules, and program data. The storage medium(s) 112 may implement a file system, a flat memory architecture, a database, or any other method or combination capable of storing such information.

A user may enter commands and information into the mobile device 100 through touch screen display 104 or the one or more other input device(s) 110 such as a keypad, keyboard, tactile buttons, camera, motion sensor, position sensor, light sensor, biometric data sensor, accelerometer, or a pointing device, commonly referred to as a mouse, trackball or touch pad. Other input devices of the mobile device 100 may include a microphone, joystick, thumbstick, game pad, optical scanner, other sensors, or the like. These and other input devices are often connected to the CPU 108 through a user input interface that is coupled to the system bus 124, but may be connected by other interface and bus structures, such as a parallel port, serial port, wireless port, game port or a universal serial bus (USB). Generally, a unique software driver stored in software 114 configures each input mechanism to sense user input, and then the software driver provides data points that are acted on by CPU 108 under the direction of other software 114. The display is also connected to the system bus 124 via an interface, such as the graphics engine 106. In addition to the display 104, the mobile device 100 may also include other peripheral output devices such as speakers, a printer, a projector, an external monitor, etc., which may be connected through one or more analog or digital I/O ports 116, network interface(s) 120 or wireless receiver(s) and transmitter(s) 118. The mobile device 100 may operate in a networked environment using connections to one or more remote computers or devices, such as a remote computer or device.

When used in a LAN or WAN networking environment, the mobile device 100 may be connected via the wireless receiver(s) and transmitter(s) 118 and network interface(s) 120, which may include, for example, cellular receiver(s) and transmitter(s), Wi-Fi receiver(s) and transmitter(s), and associated network interface(s). When used in a WAN networking environment, the mobile device 100 may include a modem or other means as part of the network interface(s) for establishing communications over the WAN, such as the Internet. The wireless receiver(s) and transmitter(s) 118 and the network interface(s) 120 may be communicatively connected to the system bus 124. In a networked environment, program modules depicted relative to the mobile device 100, or portions thereof, may be stored in a remote memory storage device of a remote system.

The mobile device 100 has a collection of I/O ports 116 and/or short range wireless receiver(s) and transmitter(s) 118 and network interface(s) 120 for passing data over short distances to and from the mobile device 100 or for coupling additional storage to the mobile device 100. For example, serial ports, USB ports, Wi-Fi ports, Bluetooth® ports, IEEE 1394 (i.e., FireWire), and the like can communicatively couple the mobile device 100 to other computing apparatuses. Compact Flash (CF) ports, Secure Digital (SD) ports, and the like can couple a memory device to the mobile device 100 for reading and writing by the CPU 108 or couple the mobile device 100 to other communications interfaces such as Wi-Fi or Bluetooth transmitters/receivers and/or network interfaces.

Mobile device 100 also has a power source 122 (e.g., a battery). The power source 122 may supply energy for all the components of the mobile device 100 that require power when a traditional, wired or wireless power source is unavailable or otherwise not connected. Other various suitable system architectures and designs of the mobile device 100 are contemplated and may be utilized which provide the same, similar or equivalent functionality as those described herein.

It should be understood that the various techniques, components and modules described herein may be implemented in connection with hardware, software and/or firmware or, where appropriate, with a combination of such. Thus, the methods and apparatus of the disclosure, or certain aspects or portions thereof, may take the form of program code (i.e., instructions) embodied in tangible media, such as various solid state memory devices, DVD-RW, RAM, hard drives, flash drives, or any other machine-readable or processor-readable storage medium wherein, when the program code is loaded into and executed by a machine, such as a processor of a computer, vehicle or mobile device, the machine becomes an apparatus for practicing various embodiments. In the case of program code execution on programmable computers, vehicles or mobile devices, such generally includes a processor, a storage medium readable by the processor (including volatile and non-volatile memory and/or storage elements), at least one input device, and at least one output device. One or more programs may implement or utilize the processes described in connection with the disclosure, e.g., through the use of an API, reusable controls, or the like. Such programs are preferably implemented in a high level procedural or object oriented programming language to communicate with a computer system of mobile device 100. However, the program(s) can be implemented in assembly or machine language, if desired. In any case, the language may be a compiled or interpreted language, and combined with hardware implementations.

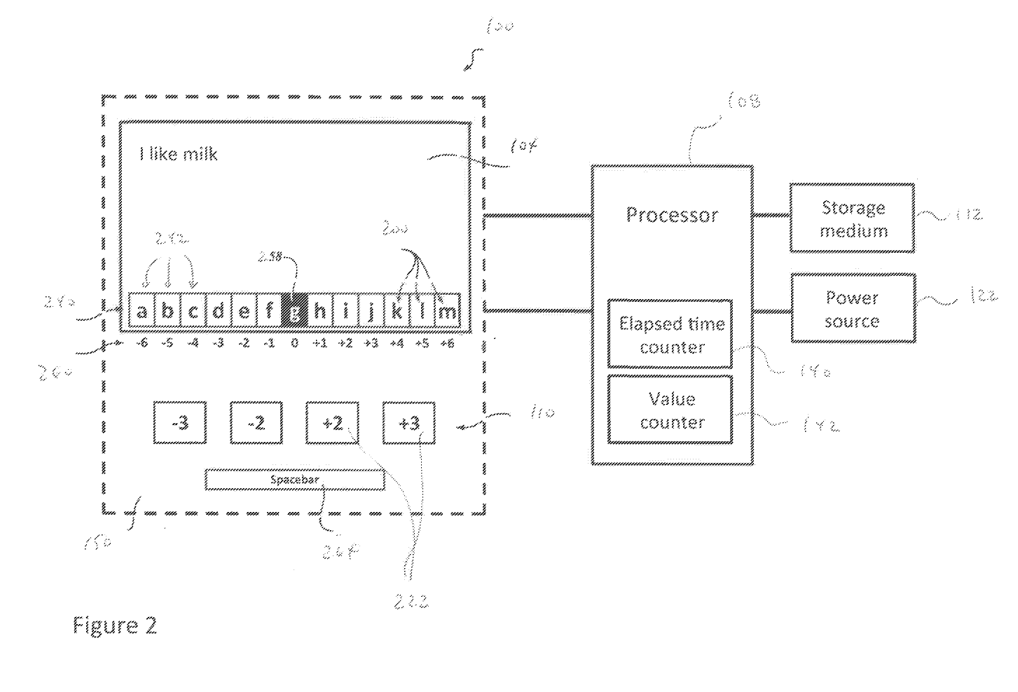

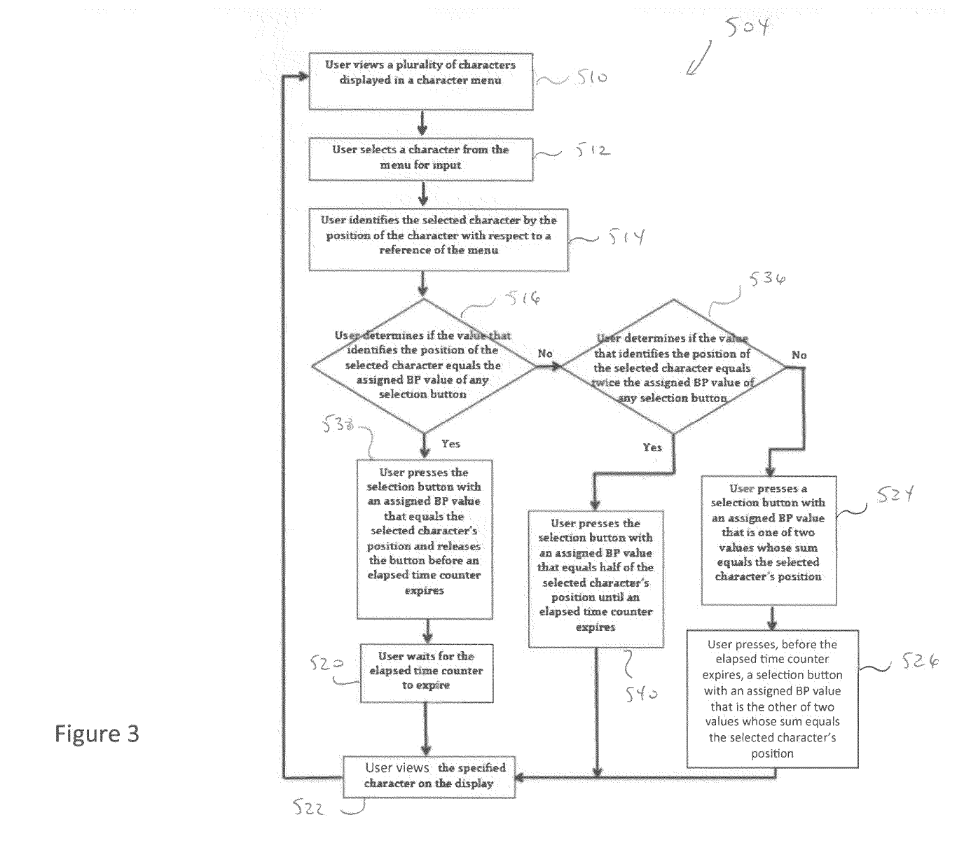

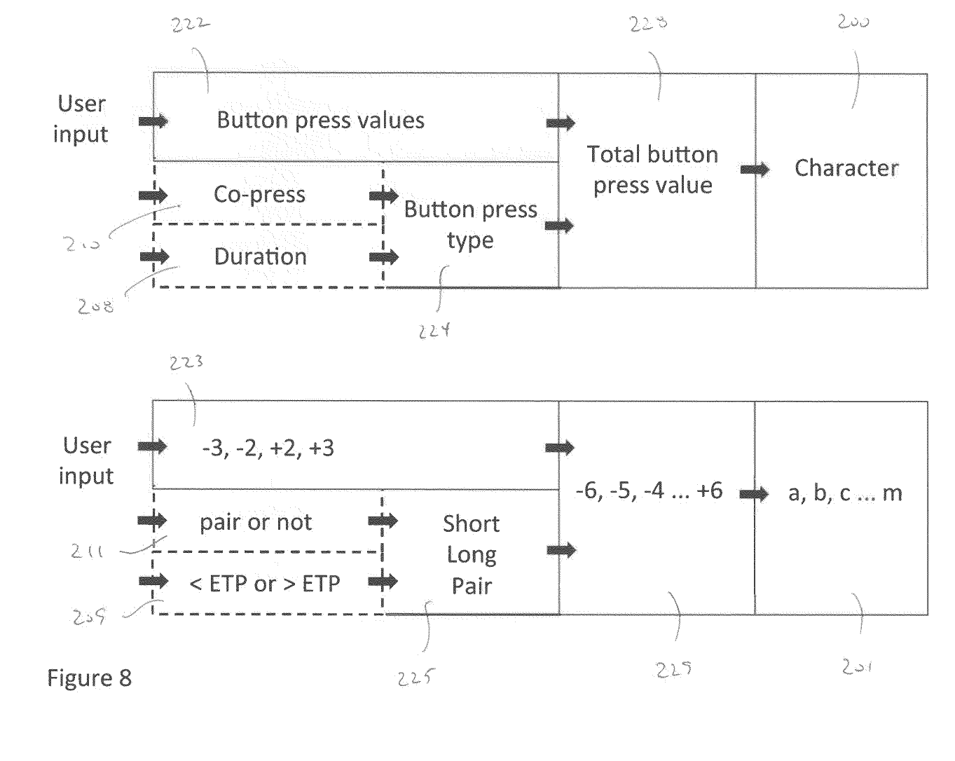

FIG. 2 shows a schematic drawing of one embodiment of the electronic device 100 for input of characters. The device 100 may have some or all of the components and functionality described herein with respect to the mobile device 100 of FIG. 1. The device 100 has aspects previously disclosed in FIG. 8 of U.S. Pat. No. 8,487,877, which is hereby incorporated by reference in its entirety.

The electronic device 100 includes the display 104, a plurality of characters 200 that populate positions 242 of a character menu 240, a plurality of selection buttons 110 and a spacebar button 264, which together make up a user interface 150 of the device 100. The user interface 150 was previously disclosed in FIG. 8 of U.S. Pat. No. 8,487,877, which is hereby incorporated by reference in its entirety. Each of the plurality of selection buttons 110 has an assigned button press value 222. Included as part of or within proximity to the menu 240 is a reference 258 and an offset scale 260. The display 104, the plurality of selection buttons 110, and the spacebar button 264 are communicatively coupled with the CPU 108, as described in the embodiment of FIG. 1. The CPU 108 includes the elapsed time counter 140 and the button press value counter 142, as described in the embodiment of FIG. 1. The CPU 108 is communicatively coupled with the storage medium 112 and the power source 122, as described in the embodiment of FIG. 1.

In the embodiment of FIG. 2, the positions 242 of the menu 240 are arranged in a one-dimensional array similar to the embodiment in FIG. 8 of U.S. Pat. No. 8,487,877, except that the menu 240 is shown on the display 104 instead of as a physical feature of the user interface 150. The plurality of selection buttons 110 can be either hard keys (physical buttons) or soft keys (buttons shown on the display 104). In the embodiment of FIG. 2, the selection buttons 110 are shown as physical buttons. In either case, the buttons 110 are communicatively coupled with the CPU 108.

The menu 240 and the offset scale 260 are positioned in respective one-dimensional arrays in the user interface region 150 of the device 100. In one embodiment the character menu 240 and the offset scale 260 are positioned on the user interface 150 so that they lie adjacent to and parallel with one other. In one embodiment, the character menu 240 and the offset scale 260 are programmed in software so that they appear as features on the display 104 of the device 100.

In one embodiment, positions 242 of the menu 240 are distributed in a one-dimensional array in evenly spaced increments. In a further embodiment, values of the offset scale 260 are distributed in a one-dimensional array in spatial increments that match the increment of the menu 240, so that by referencing the offset scale 260 to the menu 240, characters 200 in the menu are effectively numbered.

The reference 258 is an indicator located near or on one of the positions 242 of the menu 240. The offset scale 260 includes a value of zero that is located to correspond with the reference 258 of the menu 240. Values of the offset scale 260 increase from zero in pre-selected increments as positions of the offset scale get farther from the zero value. In a further embodiment, values of the offset scale 260 decrease from zero in pre-selected increments as positions of the offset scale get farther from the zero value in a direction opposite to the increasing direction. In one embodiment, the pre-selected increment of the offset scale 260 equals one and the values of the offset scale extend from a negative value to a positive value passing through zero. In an alternative embodiment, the increment of the offset scale 260 is 10 and positions 242 of the menu 240 are marked off in corresponding units of 10.

In one specific embodiment, the positions 242 of the menu 240 and the values of the offset scale 260 are distributed in respective one-dimensional arrays positioned adjacent to and parallel with one another, the values of the offset scale 260 count in increments of one and are spaced with respect to one another in their array to correspond with the spacing of positions 242 of the menu 240, and the zero value of the offset scale 260 corresponds to the reference 258 of the menu 240 so that the values of the offset scale 260 label the positions of the menu 240 according to how many positions a given position 242 of the menu 240 is offset from the reference 258.

The plurality of selection buttons 110 lie on the user interface 150 of the device 100 and, as described above, can be either hard or soft keys. In one embodiment, the buttons 110 are arranged in a row that corresponds to the physical alignment of the menu 240 on the user interface. Each button is communicatively coupled with the CPU 108 and is assigned a button press value 222. The assigned button press value 222 can be either positive or negative. Each button 110 has the function that when the button is pressed the value 222 assigned to the button is input to the CPU 108. In one embodiment, the assigned button press value 222 of each selection button is unique. In another embodiment there are four selection buttons and the buttons' assigned values are −3, −2, +2, and +3. In another embodiment there are four selection buttons and the buttons' assigned values are −3, −1, +1, and +3.

The spacebar 264 also lies in the user interface region 150 of the device 100, can be either a hard or soft key, and is communicatively coupled with the CPU 108.

In one embodiment of FIG. 2, the menu 240 has 13 menu positions 242 and the plurality of selection buttons includes four buttons with the assigned button press values 222: ‘−3, −2, +2, +3’. In a further embodiment, the menu positions 242 are populated by 13 of the 26 characters 200 of the English alphabet.

FIG. 3 shows a flowchart of an embodiment of a method 504 for a user to specify a character from among a plurality of characters. In one step 510 of the method 504, a user views the characters 200 displayed in the menu 240. In another step 512, the user selects a character from the menu 240 for input to the electronic device 100. In another step 514, the user identifies the selected character by the position of the character with respect to the reference 258 of the menu 240, for example by a value equal to the number of positions the selected character is offset from the menu's reference 258. The user can identify the position of the selected character in a number of ways, including by referencing the position to a corresponding value in the offset scale 260, counting the number of positions that the selected character is offset from the reference 258, recalling from memory the value that identifies the particular selected character, and recalling by muscle memory the selection button keystrokes that correspond with the selected character or the selected character's position.

In another step 516, the user determines whether the value that identifies the selected character's position 242 in the menu 240 equals the assigned button press value 222 of any selection button 110.

If so, in another step 538 the user presses the selection button with the assigned value that equals the selected character's position and releases the button before the elapsed time counter expires. The aforementioned step 538 inputs the assigned value 222 of the pressed selection button to the CPU 108, triggers the CPU 108 to start the elapsed time counter 140, and indicates to the CPU that the type of button press is a ‘short’ press. In a subsequent step 520, the user waits for the elapsed time counter 140 to expire before, in an optional step 522, the user views the specified character on the display 104. In an alternative embodiment, step 522 is bypassed.

However, if the value that identifies the selected character's position 242 in the menu 240 is not equal to the assigned value of any selection button, then in an alternate step 536, the user determines whether the value that identifies the selected character's position 242 in the menu 240 equals twice the assigned button press value 222 of any selection button 110.

If so, in another step 540 the user presses the selection button 110 with the assigned value 222 that equals half the selected character's position and maintains the button press until the elapsed time counter expires. The aforementioned step 540 inputs the assigned value 222 of the pressed selection button to the CPU 108, triggers the CPU 108 to start the elapsed time counter 140, and indicates to the processor that the type of button press is a ‘long’ press. In an optional step 522, the user views the specified character on the display 104. In an alternative embodiment, step 522 is bypassed.

However, if none of the values 222 assigned to the selection buttons 110 equals the selected character's position 242 or is half the selected character's position, in an alternate step 524 the user presses the selection button with the assigned value 222 that is one of two values whose sum equals the selected character's position. The aforementioned step 524 inputs the assigned value 222 of the pressed selection button 110 to the CPU 108 and triggers the CPU to start the elapsed time counter 140. In a subsequent step 526, the user presses the selection button 110 with the assigned value 222 that is the other of two values whose sum equals the selected character's position 242 and does so before the elapsed time counter 140 expires. The aforementioned step 526 inputs the assigned value 222 of the pressed selection button 110 to the CPU 108 and indicates to the processor that the type of button press is ‘pair’. Optionally, as part of the step 526, the CPU 108 may also terminate the elapsed time counter 140. Once the user has pressed the second selection button, in another step 522 the user views the specified character on the display 104, which is an optional step and in an alternative embodiment is bypassed.

According to another embodiment of the invention, the character specification method 504 described above is used iteratively to specify series of characters from the character menu 240. In one embodiment, words and sentences are formed on the display 104 by iteratively specifying characters according the method above, with the spacebar 264 used to input spaces between words on the display.

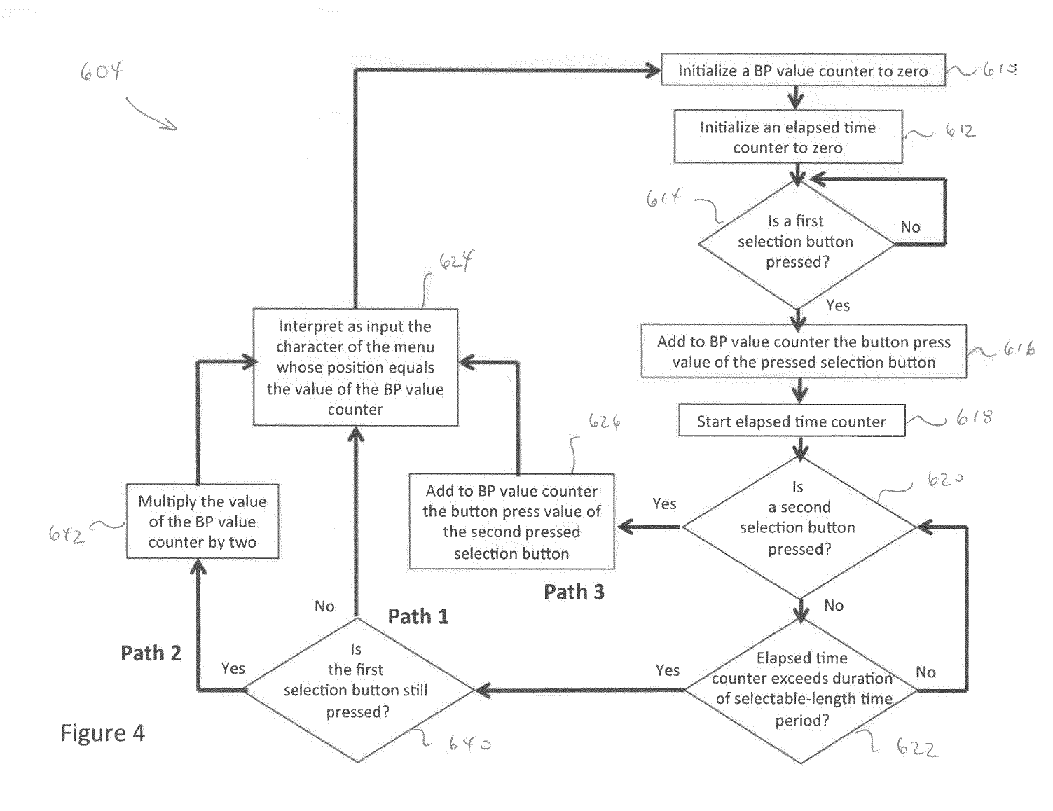

FIG. 4 shows a flowchart of an embodiment of a method 604 for the processor 108 of an electronic device to interpret button presses. In one step 610 of the method 604, the CPU 108 initializes the button press value counter 142 to zero. In another step 612 the CPU 108 initializes the elapsed time counter 140 to zero. In another step 614, the CPU 108 monitors the selection buttons 110 for a pressed selection button 110. Once a first selection button press occurs, in another step 616, the CPU 108 adds to the button press value counter 142 a value equal to the assigned value 222 of the first pressed selection button 110. In another step 618, the CPU 108 starts the elapsed time counter 140.

In a pair of steps 620, 622, the CPU 108 monitors the selection buttons 110 for the occurrence of a second selection button press while comparing the elapsed time counter 140 with a user chosen selectable-length time period.

If the elapsed time counter 140 exceeds the duration of the elapsed time period (i.e., expires) before an additional selection button press occurs, in a subsequent step 640 the CPU 108 determines if the first button press is still pressed.

If the first button press is not still pressed when the elapsed time period expires, then in a subsequent step 624 the CPU 108 interprets as input the character 200 of the menu 240 whose position 242 equals the value of the button press value counter 142.

If, however, the first button press is still pressed when the elapsed time period expires, then in an alternate subsequent step 642 the processor multiplies the value of the button press value counter 142 by two before commencing the subsequent step 624, where the CPU 108 interprets as input the character 200 of the menu 240 whose position 242 equals the value of the button press value counter 142.

If, however, in steps 620 and 622 a second selection button press occurs before the elapsed time counter 140 expires, in another step 626 the CPU 108 adds to the button press value counter 142 a value equal to the assigned value 222 of the second pressed selection button. Then, in the subsequent step 624 the CPU 108 interprets as input the character 200 of the menu 240 whose position 242 equals the value of the button press value counter 142.

According to one embodiment of the method 604, the CPU 108 re-initializes the button press value counter 142 and the elapsed time counter 140 to zero and repeats the method. According to another embodiment, in a further step the CPU 108 displays the identified character 200 on the screen 104.

In alternative embodiments, math operations other than addition and multiplication-by-two are used in steps 626 and 642 to identify characters by their numerical position in a menu, array or table. Although the method 604 of FIG. 4 is one embodiment of a method for specifying series of characters, obviously the scope of the method is not limited by this embodiment, but rather by the scope of the claims.

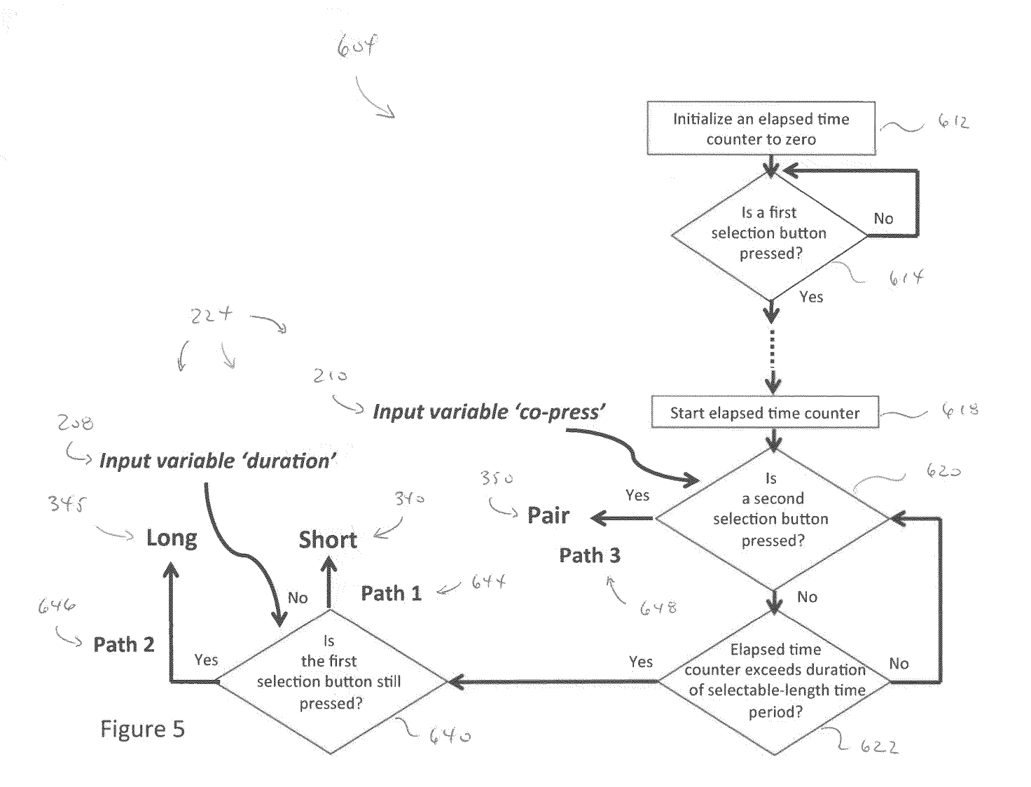

FIG. 5 shows a flowchart of the embodiment of the method 604 of FIG. 4, except that only those steps relevant to the number and duration of button presses are included. Steps relevant to the button press values 222 and the button press value counter 142 are omitted.

In the first step 612 of the method 604, the CPU 108 initializes the elapsed time counter 140 to zero. In the next step 614, the CPU 108 monitors the selection buttons 110 for the occurrence of a first pressed selection button 110. Once a first selection button press occurs, in another step 618, the CPU 108 starts the elapsed time counter 140.

In the pair of steps 620, 622, the CPU 108 monitors the selection buttons 110 for the occurrence of a second selection button press while comparing the elapsed time counter 140 with a user chosen selectable-length time period.

If the elapsed time counter 140 exceeds the duration of the elapsed time period (i.e., expires) before an additional selection button press occurs, in the subsequent step 640 the CPU 108 determines if the first button press is still pressed.

If the first button press is not still pressed when the elapsed time period expires, then the method 604 follows a first path 644. If, however, the first button press is still pressed when the elapsed time period expires, then the method 604 follows a second path 646. If, however, a second selection button press occurs in step 620 before the elapsed time counter 140 expires, then the method 604 follows a third path 648.

FIG. 5 shows that with regard to the number and duration of button presses, the method 604 has three possible outcomes. Each outcome is a possible value of a variable ‘button press type’ 224. The button press type 224 for the first path 644 is a ‘short’ button press type 340. The button press type 224 for the second path 646 is a ‘long’ button press type 345. The button press type 224 for the third path 648 is a ‘pair’ button press type 350.

FIG. 5 also makes clear that two specific steps of the method, steps 620 and 640, determine the button press type 224 of any given cycle of the method 604. At step 640, an input variable ‘duration’ 208 determines whether the button press type 224 is ‘short’ 340 or ‘long’ 345. At step 620, an input variable ‘co-press’ 210 determines whether the button press type is ‘pair’ or one of the other two types. Together, the input variables co-press 210 and duration 208 determine the button press type 224 for a cycle.

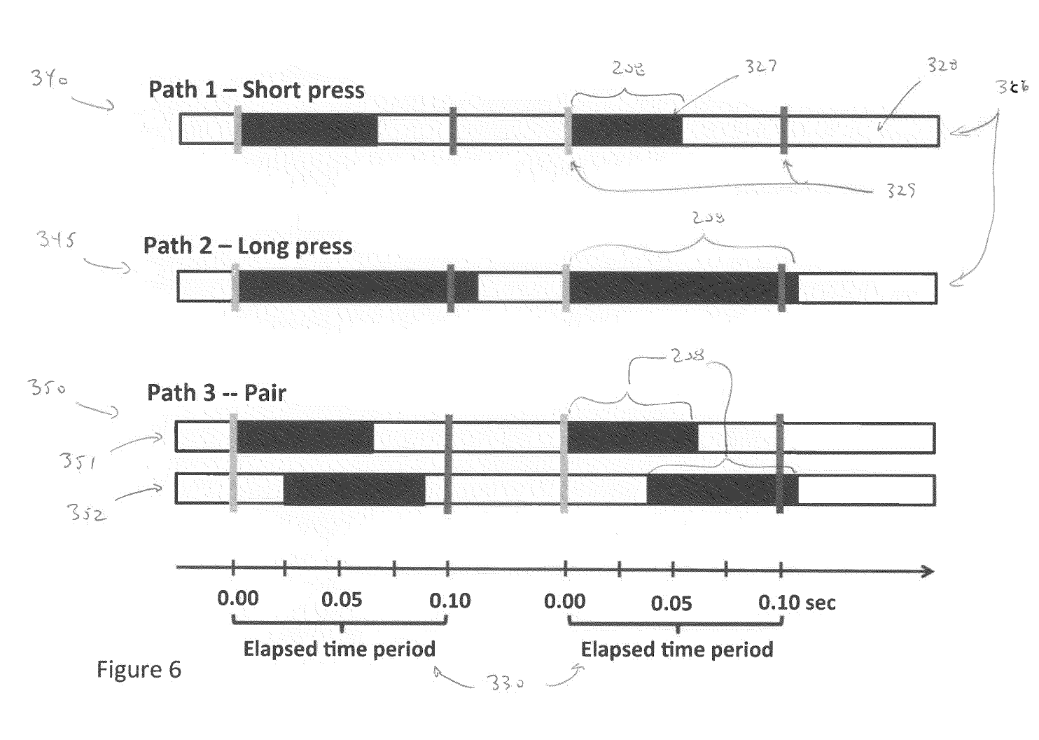

FIG. 6 shows graphical representations of examples of each of the three button press types (BPTs) 224. Two examples of each type are shown. For each example, the passage of time is represented by a horizontal bar 326. A black region 327 within the bar 326 indicates a period of time when a button is pressed. A white region 328 within the bar 326 indicates a period of time when a button is not pressed. A solid vertical marker 329 indicates the beginning or end of an elapsed time period (ETP) 330.

One button press type represented is the ‘short’ button press type 340. As dictated by steps 614 and 618 of the method 604 of FIG. 4, the elapsed time period 330 commences with the onset of the button press. In the case of the short BPT 340, the duration 208 of the button press is less than the length of the elapsed time period 330.

Another button press type shown is the ‘long’ button press type 345. As with the short BPT 340, the elapsed time period 330 commences with the onset of the button press. In the case of the long BPT 345, the duration 208 of the button press is greater than the length of the elapsed time period 330.

Another button press type shown is the ‘pair’ button press type 350. As with the short and long BPTs, the elapsed time period 330 commences with the onset of the button press, in this case with a first button press 351 of the pair. As shown in step 620 of the method 604 of FIG. 5, for the pair BPT 350 a second button press commences before expiration of the elapsed time period 330, which in FIG. 6 appears as a second button press 352 in parallel with the first button press 351. Note that the onset of the second button press 352 of the pair does not start a new elapsed time period. A button press starts a new elapsed time period when the elapsed time period 330 is not already underway. Also note that for the pair BPT 350, the duration 208 of the button presses 351, 352 is inconsequential.

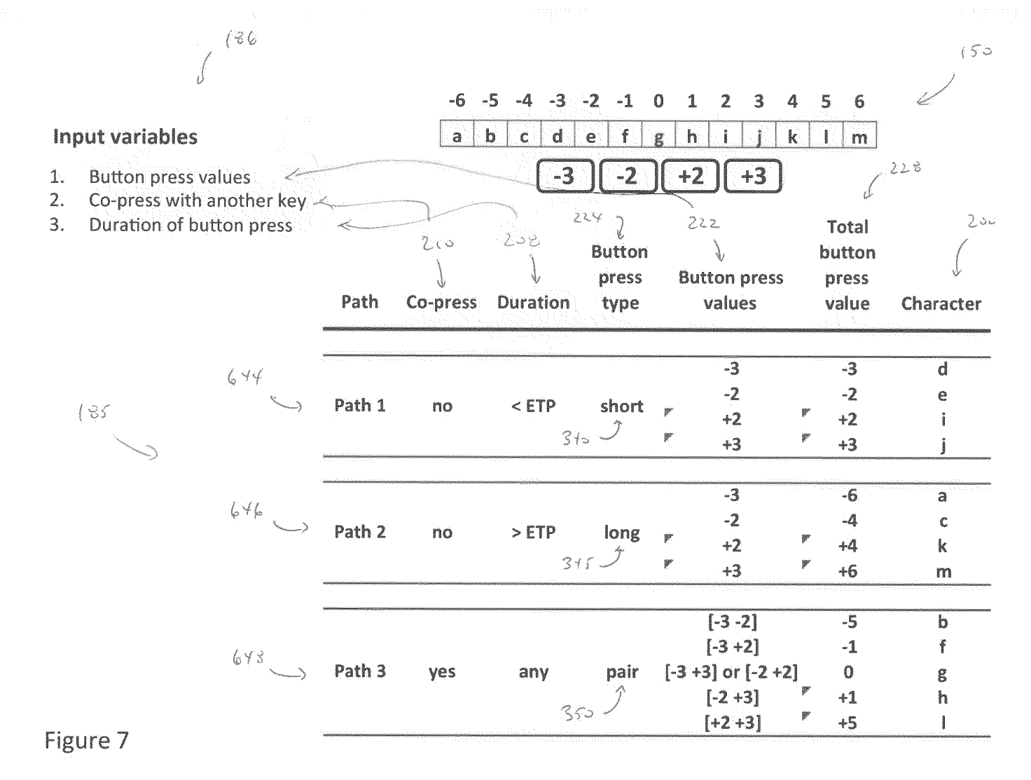

FIG. 7 shows the user interface 150 of FIG. 2, a table 185 of value assignments for variables of the method 604 of FIG. 4, and a list 186 of input variables for the method 604. The user interface 150, table 185, and list 186 are examples used to demonstrate the embodiments of FIGS. 2 and 4. The scope of the invention is not limited by the variables and values shown here, but rather by the scope of the claims.

The table 185 is divided into rows and columns. Rows are grouped by path: the first path 644, the second path 646 and the third path 648. Each column is one variable: the variable ‘co-press’ 210, the variable ‘duration’ 208, the variable ‘button press type’ 224, the variable ‘button press values’ 222, a variable ‘total button press value’ 228 and the variable ‘character’ 200.

Values for the variable ‘button press type (BPT)’ 224 agree with the path, as defined by the method 604 of FIG. 5: the first path 644 is the short BPT 340, the second path 646 is the long BPT 345, and the third path 648 is the pair BPT 350.

Values for the variables ‘co-press’ 210 and ‘duration’ 208 align with the values for ‘BPT’ 224 as dictated by the method 604 of FIG. 5: when ‘co-press’ is ‘no’ and ‘duration’ is ‘<ETP’, then the BPT is short; when ‘co-press’ is ‘no’ and ‘duration’ is ‘>ETP’, then the BPT is long; and when ‘co-press’ is ‘yes’ and ‘duration’ is ‘any’, then the BPT is pair.

Values for the variable ‘button press values’ 222 are the assigned button press values 222 (or possible combinations of the assigned values 222) of the user interface 150. For the short and long BPTs, the button press values 222 are single values. For the pair BPT, the button press values 222 are possible combinations of two of the values 222. The variable ‘button press value’ 222 identifies for the processor 108 the particular selection button 110 pressed. For the user interface 150 of FIG. 2, values for variable ‘button press values’ 222 are −3, −2, +2 +3, and possible combinations of any two of those values. In alternative embodiments, other values for the variable ‘button press values’ 222 are possible.

Values for the variable ‘total button press value’ 228 are the values that result from the mathematical operations of steps 624, 626 and 642 of the method 604 of FIG. 4. As the method 604 of FIG. 4 shows, the path taken determines which math operation gets implemented. As a result, values of the variable ‘total button press value’ 228 depend on both the variables ‘button press values’ 222 and ‘button press type’ 224. For the short BPT 340, the ‘total button press value’ 228 equals the ‘button press value’ 222. For the long BPT 345, the ‘total button press value’ 228 equals two times the ‘button press value’ 222. For the pair BPT 350, the ‘total button press value’ 228 equals the sum of the ‘button press values’ 222.

Values for the variable ‘character’ 200 are the characters 200 available in the menu 240 of the user interface 150. Each character is identified by its position 242 in the menu 240, as previously disclosed in U.S. Pat. No. 8,487,877. As described in step 624 of the method 604 of FIG. 4, the processor 108 interprets characters 200 of the menu 242 by their position 242. Values for the variable ‘total button press value’ 228 identify that menu position 242.

The list 186 shows explicitly which variables of the method 604 of FIG. 4 are input variables. Input variables are variables that require input from a user. The input variables are: (1) ‘button press values’ 222, (2) ‘co-press’ 210 and (3) ‘duration’ 208. The remaining variables of the table 185 (button press type′ 224, ‘total button press value’ 228, and ‘character’ 200) all follow as a consequence of the input variables and the user interface 150.

FIG. 8 shows a first flowchart of variables and a second flowchart of example values for each variable of the method 604 of FIG. 4 and the user interface 150 of FIG. 2.

The first flowchart shows the three input variables for the method of FIG. 4: (1) ‘button press values’ 222, (2) ‘co-press’ 210, and (3) ‘duration’ 208. Next in the flowchart, the variables ‘co-press’ 210 and ‘duration’ 208 together determine the ‘button press type’ 224, as disclosed by the method 604 of FIG. 4 and particularly by the aspects of the method 604 shown in FIG. 5. Next, the variables ‘button press values’ 222 and ‘button press type’ 224 together determine the ‘total button press value’ 228, which follows step 624, 626, or 642 of the method 604 of FIG. 4. Finally, the variable ‘total button press value’ 228 determines the ‘character’ 200 which is based on the menu 240 of the user interface 150 of FIG. 2.

The second flowchart shows example values for each variable of the method 604 of FIG. 4 and the embodiment of the user interface 150 of FIG. 2. The variable ‘button press values’ 222 has the values ‘−3, −2, +2 or +3’ 223 (or combinations of them). The variable ‘co-press’ 210 has the values ‘pair’ or ‘not’ 211. The variable ‘duration’ 208 has the values ‘<ETP’ or ‘>ETP’ 209. The variable ‘button press type’ 224 has the values ‘short’, ‘long’ or ‘pair’ 225. The variable ‘total button press value’ 228 has the values ‘−6, −5, −4, −3, −2, −1, 0, +1, +2, +3, +4, +5, or +6’ 229. The variable ‘character’ 200 has the values ‘a, b, c, d, e, f, g, h, i, j, k, 1, or m’ 201. The values of the second flowchart are examples used to demonstrate the embodiments of FIGS. 2 and 4. The scope of the invention is not limited by the variables and particular values shown here, but rather by the scope of the claims.

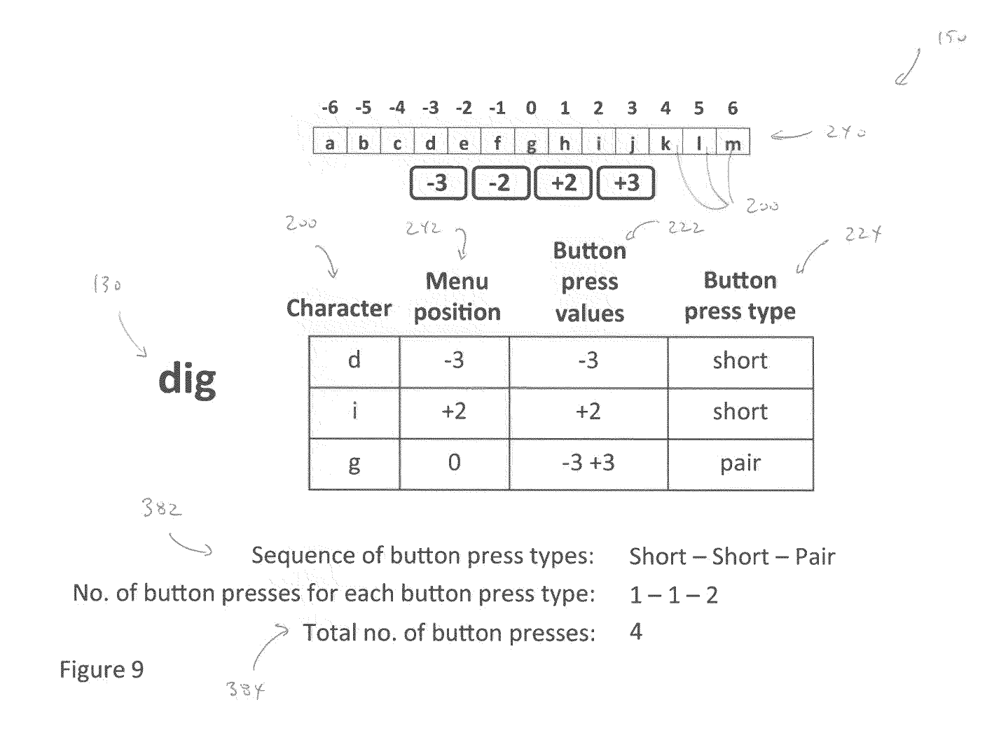

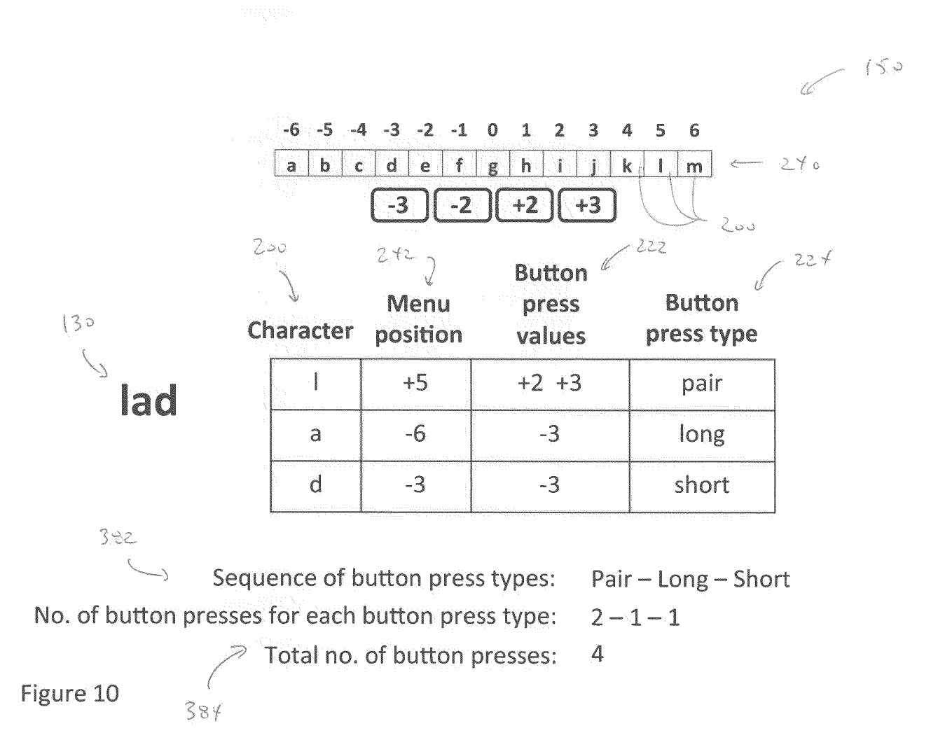

FIGS. 9 and 10 show examples of how characters of a word 130 derive from the variables of the method 604 of FIG. 4 and the user interface 150.

For the example of FIG. 9, the word 130 is ‘dig’. Rows of a table show values for each of the variables ‘character’ 200, ‘menu position’ 242, ‘button press values’ 222 and ‘button press type’ 224. Values for the variable ‘character’ 200 derive directly from the word 130. Values for the variable ‘menu position’ 242 derive from the position of each character 200 in the menu 240 according to the user interface 150.

Values for the variable ‘button press values’ 222 derive from the values for ‘menu position’ 242 and steps 624 and 626 of the method 604 taken in reverse. In other words, for example, in order for the method 604 of FIG. 4 and the user interface 150 of FIG. 2 to interpret the ‘menu position’ as −3, thereby leading to the character ‘d.’, then the button press value can only be −3. For the assigned selection buttons 222 available in the user interface 150 of FIG. 2, no combination of one or two button press values 222 except −3 can produce the value −3. As another example, to interpret the ‘menu position’ as +2, thereby leading to the character ‘i’, then the button press value can only be +2. For the assigned selection buttons 222 available in the user interface 150 of FIG. 2, no combination of one or two button press values 222 except +2 can produce the value +2. The logic is the same for ‘g’, although it offers two possibilities to produce 0: −3 and +3 or −2 and +2.

Values for the variable ‘button press type’ 224 derive from the values for ‘menu position’ 242 in the same way. In order for the method 604 of FIG. 4 and the user interface 150 of FIG. 2 to interpret the ‘menu position’ 242 as −3, the method must follow the first path 644. Review of FIGS. 4 and 5 confirms this, because neither the mathematical operation of step 642 along the second path 646 or the math operation of step 626 along the third path 648 allow an outcome of −3 for the assigned selection button values 222 that are available for the user interface 150. With the restriction that the first path 644 of the method 604 must be the one followed, then the ‘button press type’ 224 must be the short BPT 340, for the reasons explained in FIG. 5. Similar logic holds true for the other rows of the example.

The examples above hint at three facts true of the method 604 of FIG. 4 and the user interface 150 of FIG. 2 that make the method and interface useful:
1) every menu position 242 is accessible by at least one combination of the variables ‘button press values’ 222 and ‘button press types’ 224,
2) every combination of the variables ‘button press values’ 222 and ‘button press types’ 224 leads to at least one menu position 242, and
3) every combination of the variables ‘button press values’ 222 and ‘button press types’ 224 leads to no more than one menu position 242.

FIG. 9 also shows a variable ‘button press type sequence’ 382 and a variable ‘total number of button presses’ 384. For the word ‘dig’, the button press type sequence 382 is ‘short-short-pair’. Based on the number of button press types 224 and the number of button press values 222 per button press type 224, the total number of button presses 384 for the word ‘dig’ is four.

For the example of FIG. 10, the word 130 is ‘lad’. Rows of a table show values for each of the variables ‘character’ 200, ‘menu position’ 242, ‘button press values’ 222 and ‘button press type’ 224. Individual values for each of the variables are derived just as explained for the example of FIG. 9. For the word ‘lad’, the button press type sequence 382 is ‘pair-short-long’. Based on the number of button press types 224 and the number of button press values 222 per button press type 224, the total number of button presses 384 for the word ‘lad’ is four.

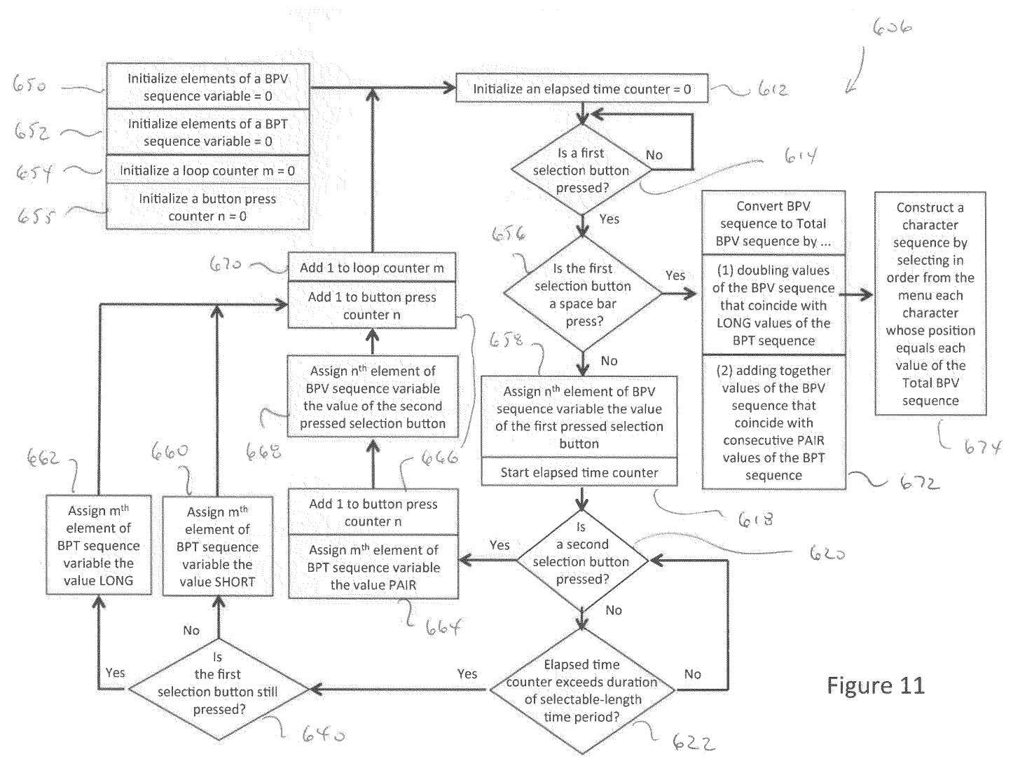

FIG. 11 shows a flowchart of an embodiment of a method 606 for the processor 108 of an electronic device to interpret sequences of button presses.

In one step 650 of the method 606, the CPU 108 initializes elements of an array variable ‘sequence of button press values’ 380 to zero. In another step 652 the CPU 108 initializes elements of an array variable ‘sequence of button press types’ 382 to zero. In another step 654 the CPU 108 initializes a variable ‘loop counter m’ 390 to zero. In another step 655 the CPU 108 initializes a variable ‘button press counter n’ 392 to zero.

In another step 612 the CPU 108 initializes the elapsed time counter 140 to zero. In another step 614, the CPU 108 monitors the selection buttons 110 for a pressed selection button 110. Once a first selection button press occurs, in another step 656, the CPU 108 determines if the first pressed selection button 110 is a press of the spacebar 264. If not, in a next step 658, the CPU 108 assigns to the n^{th} element of the BPV sequence variable 380 the assigned value 222 of the first pressed selection button 110.

In another step 618, the CPU 108 starts the elapsed time counter 140. In a pair of steps 620, 622, the CPU 108 monitors the selection buttons 110 for the occurrence of a second selection button press while comparing the elapsed time counter 140 with a user chosen selectable-length time period.

If the elapsed time counter 140 exceeds the duration of the elapsed time period (i.e., expires) before an additional selection button press occurs, in a subsequent step 640 the CPU 108 determines if the first button press is still pressed.

If the first button press is not still pressed when the elapsed time period expires, then in a subsequent step 660 the CPU 108 assigns to the m^{th} element of the BPT sequence variable 382 the value ‘short’ 340.

If, however, the first button press is still pressed when the elapsed time period expires, then in an alternate subsequent step 662 the CPU 108 assigns to the m^{th} element of the BPT sequence variable 382 the value ‘long’ 345.

If, however, in step 620 a second selection button press occurs before the elapsed time counter 140 expires, in another step 664 the CPU 108 assigns to the m^{th} element of the BPT sequence variable 382 the value ‘pair’ 350. Then, in a subsequent step 666 the CPU 108 adds 1 to the variable button press counter n 392. Then, in a subsequent step 668 the CPU 108 assigns to the n^{th} element of the BPV sequence variable 380 the assigned value 222 of the second pressed selection button 110. Then, in the subsequent step 666 the CPU 108 again adds 1 to the variable button press counter n 392. Then, in a subsequent step 670 the CPU 108 adds 1 to the variable loop counter m 390.

According to one embodiment of the method 606, the CPU 108 re-initializes the elapsed time counter 140 to zero and repeats the method in succession until in the step 656 the CPU 108 finds that the selection button pressed in step 614 is a press of the spacebar 264.

Then, in an alternative step 672 the CPU 108 converts the values of the BPV sequence variable 380 to values of a variable ‘total BPV sequence’ 386 by: (1) doubling values of the BPV sequence 380 that coincide with ‘long’ BPT values 345 of the BPT sequence 382, and (2) adding together values of the BPV sequence 380 that coincide with consecutive ‘pair’ BPT values 350 of the BPT sequence 382.

In the case of pairs occurring consecutively in the BPT sequence 382 (i.e., pairs of pairs), no value of the BPV sequence 380 is added to more than one other value. Furthermore, additions are made so that every value of the BPV sequence 380 that coincides with a pair BPT 350 gets added to a consecutive value of the BPV sequence that also coincides with a pair BPT and in such a way that no BPV that coincides with a pair BPT goes un-added.

Then, in a subsequent step 674 the CPU 108 constructs a character sequence 388 by identifying in order from the menu 240 each character 200 whose position 242 equals a value of the total BPV sequence 386.

Although the method 606 of FIG. 11 is one embodiment of a method for a processor 108 to interpret sequences of button presses, the scope of the method is not limited by this embodiment, but rather by the scope of the claims.

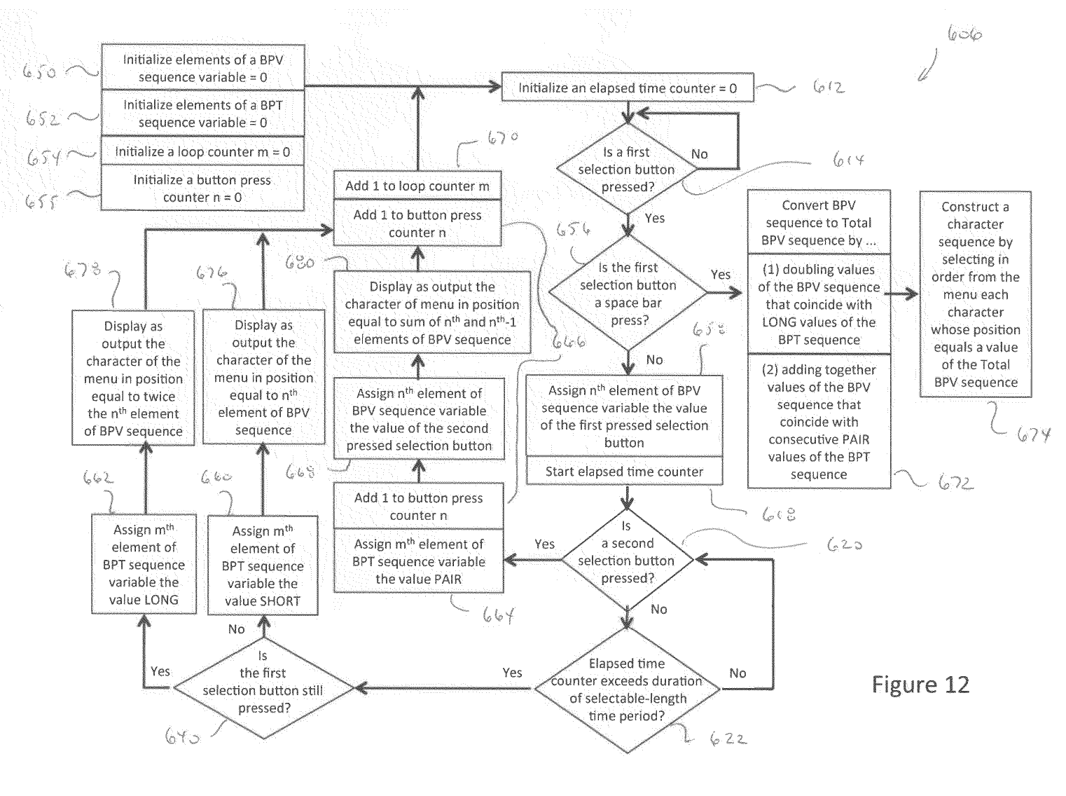

FIG. 12 shows a further embodiment of the method 606 that includes additional steps that display the character 200 interpreted in the most recent cycle of the method on the display 104 of the electronic device 100.

In a further step 676, the CPU 108 displays as output the character 200 of the menu 240 in the position 242 equal to the n^{th} element of the BPV sequence 380. In a further step 678, the CPU 108 displays as output the character 200 of the menu 240 in the position 242 equal to twice the n^{th} element of the BPV sequence 380. In a further step 680, the CPU 108 displays as output the character 200 of the menu 240 in the position 242 equal to the sum of the n^{th} and n^{th}−1 elements of the BPV sequence 380.

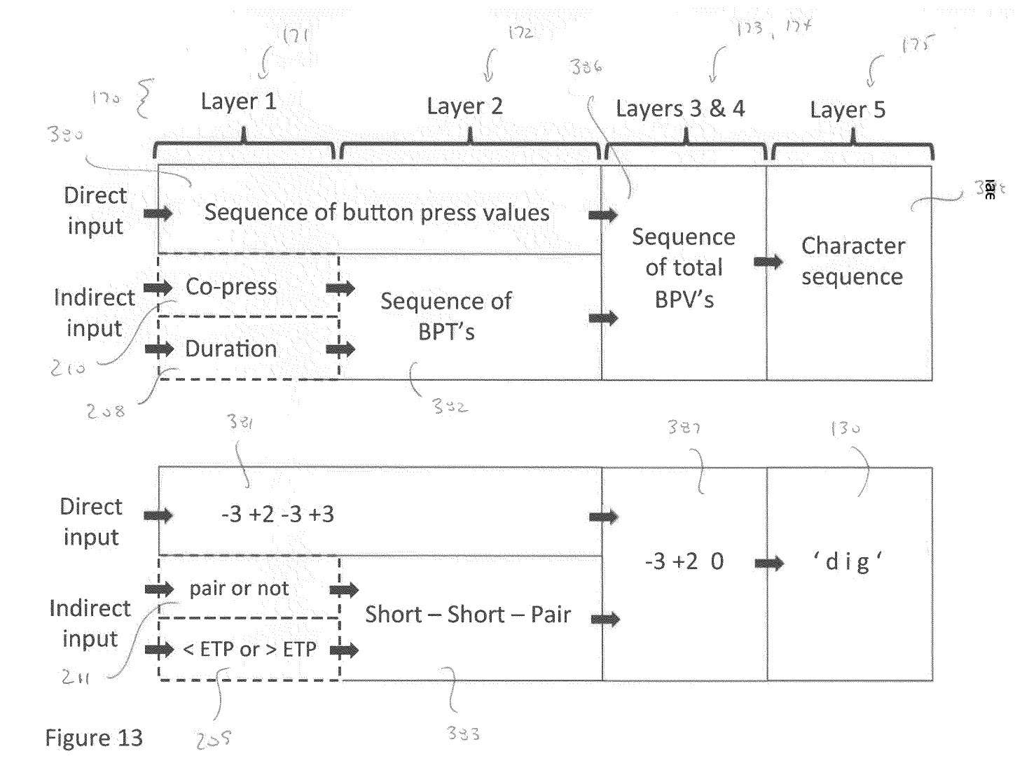

FIG. 13 shows a first flowchart of variables and a second flowchart of example values for each variable for the method 606 of FIG. 11 and the user interface 150 of FIG. 2.

The first flowchart shows that three input variables exist for the method 606 of FIG. 11: (1) ‘sequence of button press values’ 380, (2) ‘co-press’ 210, and (3) ‘duration’ 208. Next in the flowchart, the variables ‘co-press’ 210 and ‘duration’ 208 together determine the variable ‘sequence of button press types’ 382, which occurs as a result of repeated loops through steps 620 and 640 of FIG. 11. Next, the variables ‘sequence of button press values’ 380 and ‘sequence of button press types’ 382 together determine the variable ‘sequence of total button press values’ 386, which occurs in step 672 of the method 606 of FIG. 11. Finally, the variable ‘sequence of total button press values’ 386 determines the variable ‘character sequence’ 388 which occurs in step 674 of the method 606 and is based on the user interface 150 of FIG. 2.

The second flowchart shows example values for each variable for the embodiment of the user interface 150 of FIG. 2. The variable ‘sequence of button press values’ 380 has the value ‘−3 +2 −3 +3’ 381. The variable ‘co-press’ 210 has the values ‘pair’ or ‘not’ 211. The variable ‘duration’ has the values ‘<ETP’ or ‘>ETP’ 209. The variable ‘sequence of button press types’ 383 has the value ‘short-short-pair’ 383. The variable ‘sequence of total button press values’ 386 has the value ‘−3 +2 0’ 387. The variable ‘character sequence’ 388 has the value ‘d i g’ 130. The values of the second flowchart are examples used to demonstrate the embodiments of FIGS. 2 and 11. The scope of the invention is not limited by the variables and particular values shown here, but rather by the scope of the claims.

The method 606 of FIG. 11 can be divided into a series of layers 170. Each layer is one or more steps of the method 606 and is defined by the variables of the layer. A first layer 171 handles the variables ‘sequence of button press values’ 380, ‘co-press’ 210, and ‘duration’ 208. A second layer 172 handles the variables ‘sequence of button press values’ 380 and ‘sequence of button press types’ 382. A third layer 173 handles the variable ‘sequence of total button press values’ 386. A fourth layer 174 (not shown explicitly in FIG. 13) handles the variable ‘menu positions’ 242. A fifth layer 175 handles the variable ‘character sequence’ 388.

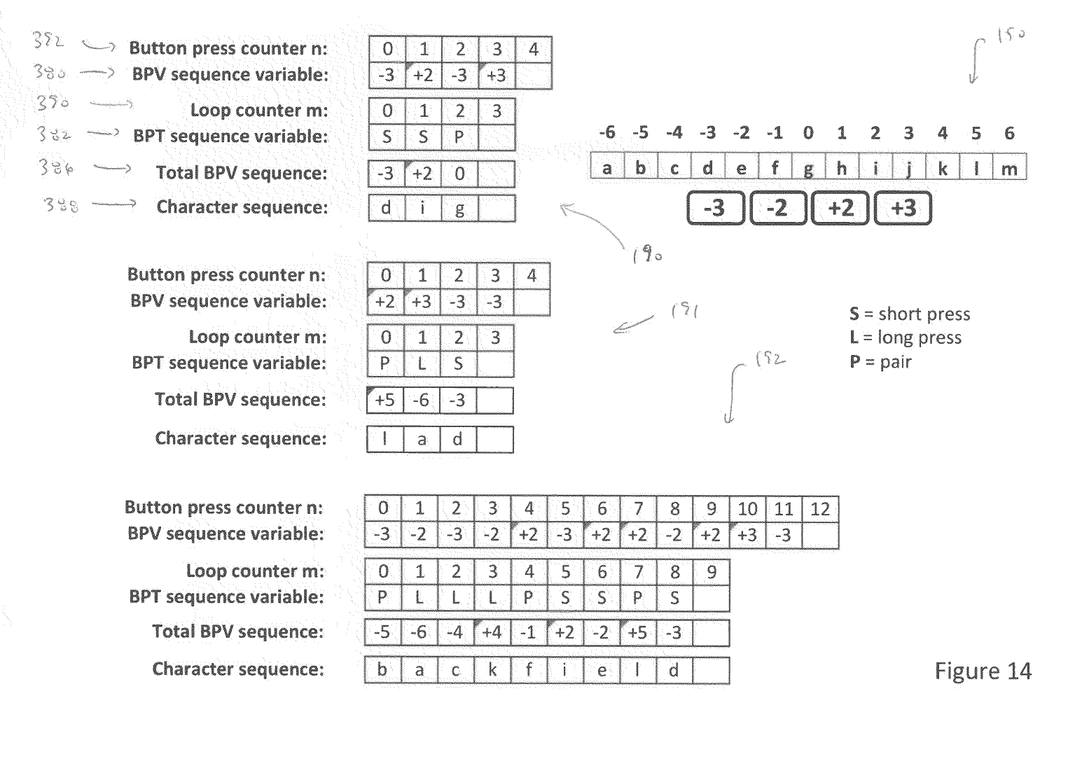

FIG. 14 shows three examples of the method 606 of FIG. 11 and the flow of variables of FIG. 13 for the user interface 150 of FIG. 2. Each example includes the variables ‘button press counter n’ 392, ‘BPV sequence’ 380, ‘loop counter m’ 390, ‘BPT sequence’ 382, ‘total BPV sequence’ 386 and ‘character sequence’ 388.

In a first example 190, the button press counter n 392 identifies the elements (0-4) of the array variable BPV sequence 380. The BPV sequence 380 contains the BPVs (−3 +2 −3 +3) 222 of each consecutive button press collected in steps 658 and/or 668 over multiple iterations of the method 606 of FIG. 11. The loop counter m 390 identifies the elements (0-3) of the array variable BPT sequence 382. The BPT sequence 382 contains the BPTs 224 (short-short-pair) collected in one of steps 660, 662, or 664 for each iteration of the method 606 of FIG. 11. The total BPV sequence 386 contains the sequence of values (−3 +2 0) that identify the menu positions 242 of the selected characters. The character sequence 388 contains the selected characters (d i g). In the first example 190, values for each of the variables of the first flowchart of FIG. 13 produce the characters of the word 130 ‘dig’.

In a second example 191, the button press counter n 392 identifies the elements (0-4) of the array variable BPV sequence 380. The BPV sequence 380 contains the BPVs (+2 +3 −3 −3) 222 of each consecutive button press collected in steps 658 and/or 668 over multiple iterations of the method 606 of FIG. 11. The loop counter m 390 identifies the elements (0-3) of the array variable BPT sequence 382. The BPT sequence 382 contains the BPTs (pair-long-short) 224 collected in one of steps 660, 662, or 664 for each iteration of the method 606 of FIG. 11. The total BPV sequence 386 contains the sequence of values (+5 −6 −3) that identify the menu positions 242 of the selected characters. The character sequence 388 contains the selected characters (l a d). In the second example 191, values for each of the variables of the first flowchart of FIG. 13 produce the characters of the word 130 ‘lad’.

In a third example 192, the button press counter n 392 identifies the elements (0-12) of the array variable BPV sequence 380. The BPV sequence 380 contains the BPVs (−3 −2 −3 −2 +2 −3 +2 +2 −2 +2 +3 −3) 222 of each consecutive button press collected in steps 658 and/or 668 over multiple iterations of the method 606 of FIG. 11. The loop counter m 390 identifies the elements (0-9) of the array variable BPT sequence 382. The BPT sequence 382 contains the BPTs (pair-long-long-long-pair-short-short-pair-short) 224 collected in one of steps 660, 662, or 664 for each iteration of the method 606 of FIG. 11. The total BPV sequence 386 contains the sequence of values (−5 −6 −4 +4 −1 +2 −2 +5 −3) that identify the menu positions 242 of the selected characters. The character sequence 388 contains the selected characters (b a c k f i e l d). In the third example 192, values for each of the variables of the first flowchart of FIG. 13 produce the characters of the word 130 ‘backfield’.

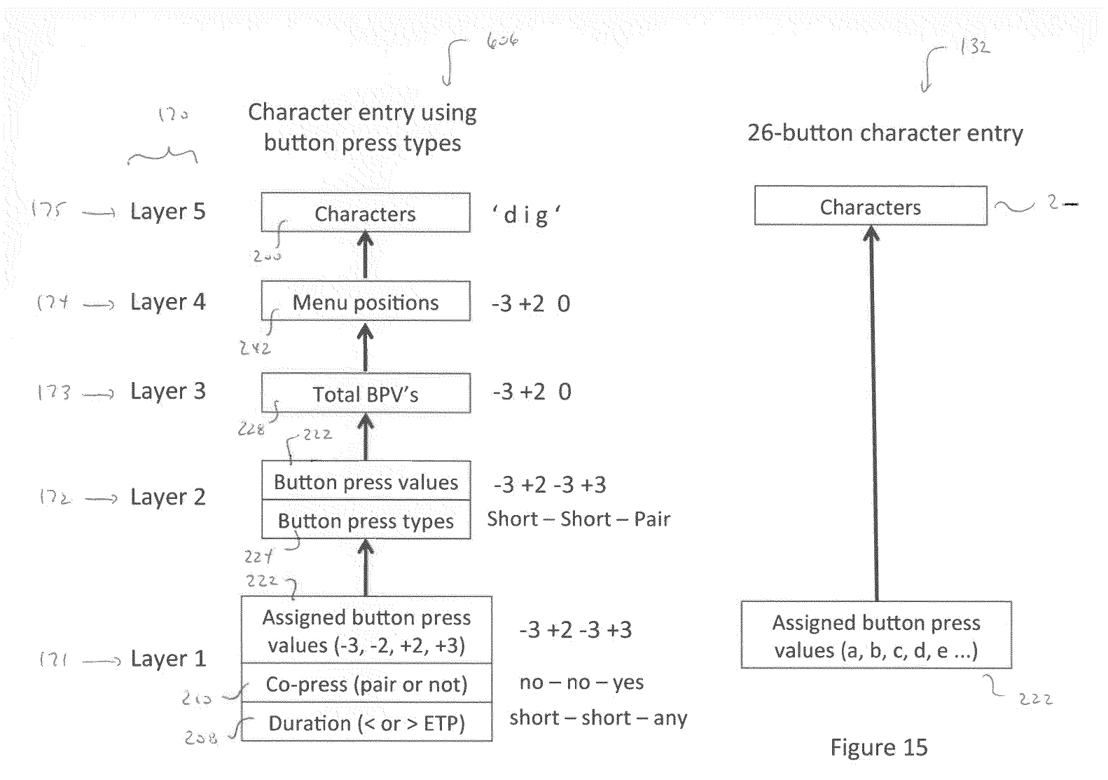

FIG. 15 compares the variables of the typical 26-button character entry method 132 with those of the method 606 of FIG. 11. The 26-button input method 132 has only two variables: ‘assigned button press values’ 222 and ‘characters’ 200. For the method 132, examples of the variables ‘assigned button press values’ 222 and ‘characters’ 200 are the same: ‘a, b, c, d, e . . . ’.

The method 606 of FIG. 11 has five layers 170, each layer made up of one or more variables. In the first layer 171, the variables are ‘assigned button press values’ 222, ‘co-press’ 210, and ‘duration’ 208. In the second layer 172, the variables are ‘button press values’ 222 and ‘button press types’ 224. In the third layer 173, the variable is ‘total button press values’ 228. In the fourth layer 174, the variable is the ‘menu positions’ 242.

In the fifth layer 175, the variable is ‘characters’ 200. Examples of sequences of values for each variable are also shown. The description of FIG. 13 explains how variables of each layer 170 of FIG. 15 correspond with the steps of the method 606 of FIG. 11.

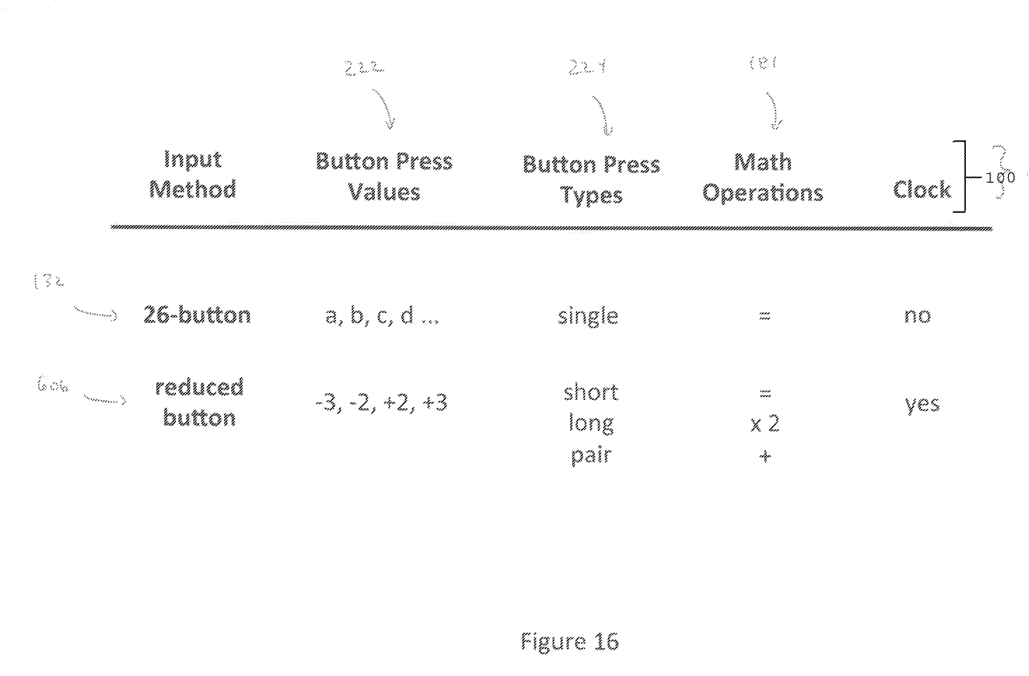

FIG. 16 is a table that compares various characteristics 180 of the typical 26-button character entry method 132 with those of the method 606 of FIG. 11 through example values. The characteristics compared are the variable ‘button press values’ 222, the variable ‘button press types’ 224, math operations 181 and if there is a clock or not. For the 26-button method 132, typical values for the variable ‘button press values’ 222 are the characters themselves: ‘a, b, c, d, e . . . ’. For the method 606 of FIG. 11, typical values for the variable ‘button press types’ 224 are numerical values: ‘−3, −2, +2, +3’. The 26-button method 132 has only one value for the variable ‘button press types’ 224: ‘single’. The method 606 of FIG. 11 has three ‘button press types’ 224: ‘single’, ‘short’ and ‘pair’. The 26-button method 132 has one math operation: ‘equals’. The method 606 of FIG. 11 has three math operations 181: ‘equals’, ‘times 2’, and ‘sum’. The 26-button method 132 is time-independent and therefore has no clock, whereas the method 606 of FIG. 11 has time-dependent button presses and therefore the elapsed time counter 140.

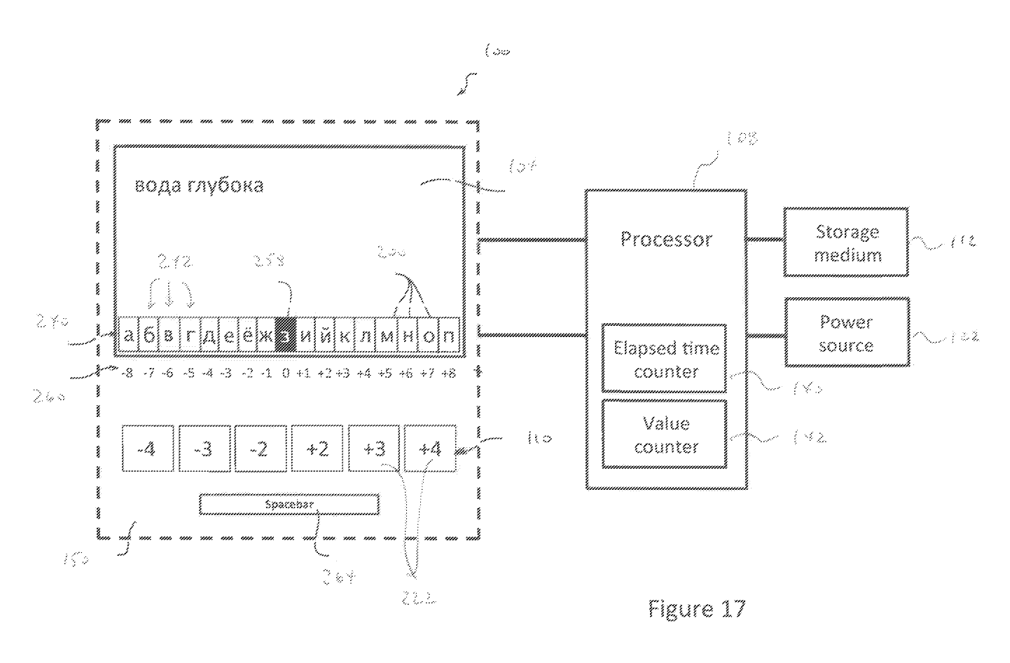

FIG. 17 shows a schematic drawing of another embodiment of the electronic device 100 for input of characters. The device 100 may have some or all the components and functionality described herein with respect to the mobile device 100 of FIG. 1. The device 100 has aspects previously disclosed in FIG. 8 of U.S. Pat. No. 8,487,877, which is hereby incorporated by reference in its entirety.

The electronic device 100 includes the display 104, the plurality of characters 200 that populate positions 242 of the character menu 240, the plurality of selection buttons 110 and the spacebar button 264, which together make up the user interface 150 of the device 100. Each of the plurality of selection buttons 110 has an assigned button press value 222. Included as part of or within proximity to the menu 240 is the reference 258 and the offset scale 260. The display 104, the plurality of selection buttons 110, and the spacebar button 264 are communicatively coupled with the CPU 108, as described in the embodiment of FIG. 1. The CPU 108 includes the elapsed time counter 140 and the button press value counter 142, as described in the embodiment of FIG. 1. The CPU 108 is communicatively coupled with the storage medium 112 and the power source 122, as described in the embodiment of FIG. 1.

In the embodiment of FIG. 17, the menu 240 has 17 menu positions 242 and the plurality of selection buttons includes six buttons with the assigned button press values 222: ‘−4, −3, −2, +2, +3, +4’. In a further embodiment, the menu positions 242 are populated by 17 of the 33 characters 200 of the Russian alphabet.

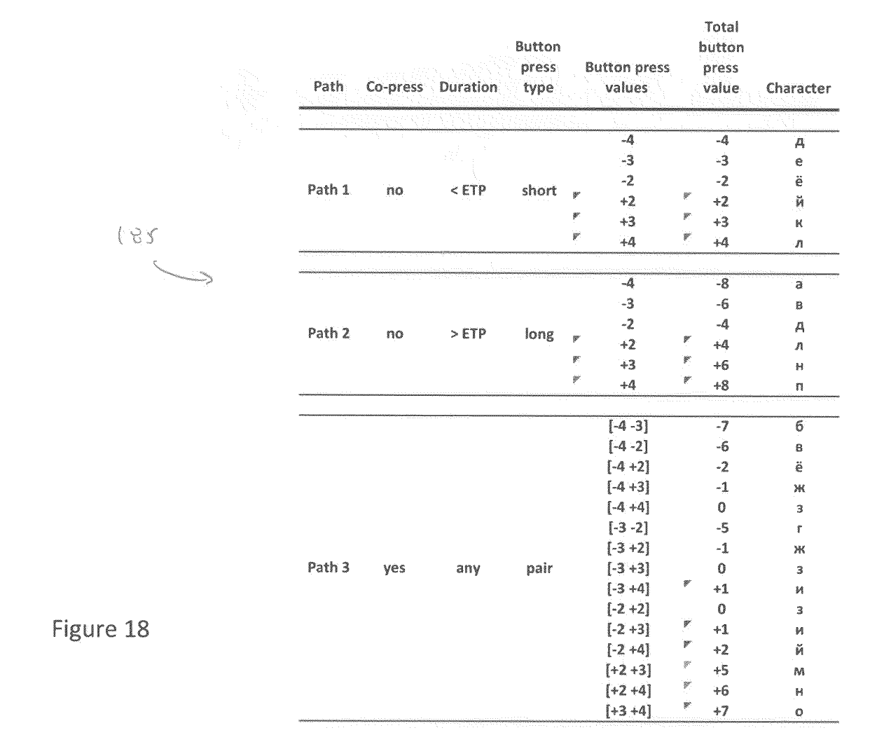

FIG. 18 shows an embodiment of the table 185 of value assignments for variables of the method 604 of FIG. 4 for the embodiment of the user interface 150 of FIG. 17.

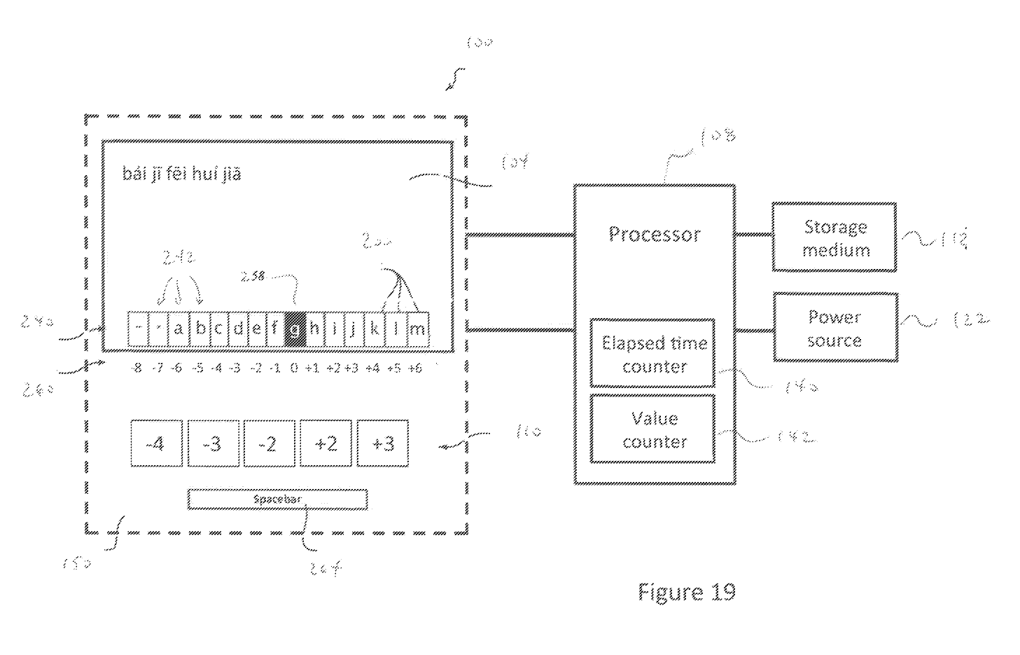

FIG. 19 shows a schematic drawing of another embodiment of the electronic device 100 for input of characters. The device 100 may have some or all the components and functionality described herein with respect to the mobile device 100 of FIG. 1. The device 100 has aspects previously disclosed in FIG. 8 of U.S. Pat. No. 8,487,877, which is hereby incorporated by reference in its entirety.

The electronic device 100 includes the display 104, the plurality of characters 200 that populate positions 242 of the character menu 240, the plurality of selection buttons 110 and the spacebar button 264, which together make up the user interface 150 of the device 100. Each of the plurality of selection buttons 110 has an assigned button press value 222. Included as part of or within proximity to the menu 240 is the reference 258 and the offset scale 260. The display 104, the plurality of selection buttons 110, and the spacebar button 264 are communicatively coupled with the CPU 108, as described in the embodiment of FIG. 1. The CPU 108 includes the elapsed time counter 140 and the button press value counter 142, as described in the embodiment of FIG. 1. The CPU 108 is communicatively coupled with the storage medium 112 and the power source 122, as described in the embodiment of FIG. 1.

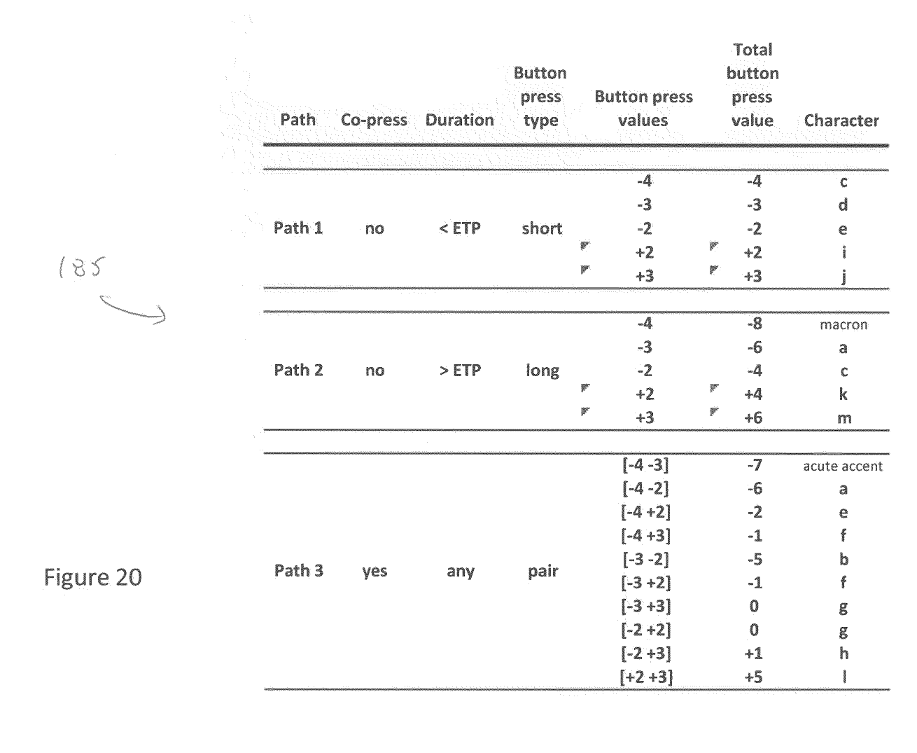

In the embodiment of FIG. 19, the menu 240 has 15 menu positions 242 and the plurality of selection buttons includes five buttons with the assigned button press values 222: ‘−4, −3, −2, +2, +3’. In a further embodiment, the menu positions 242 are populated by 13 characters 200 of the English alphabet, plus characters that represent two of the five tones used in Chinese pinyin. In a further embodiment, the two tones represented are flat (high level) and rising (high-rising). In a further embodiment, the two tones are represented by a macron and an acute accent, respectively. In an alternative embodiment, the two tones are represented by the marks ‘−’ and ‘′’, respectively. FIG. 20 shows an embodiment of the table 185 of value assignments for variables of the method 604 of FIG. 4 for the embodiment of the user interface 150 of FIG. 19.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer processor-implemented method comprising:
detecting, by at least one computer processor, onset of a first button press of a button of a plurality of buttons;
interpreting, by at least one computer processor, between first, second and third button press types based on button presses that occur during a finite-length time period measured from the onset of the first button press, the interpreting including:
interpreting, by at least one computer processor, between the first and second button press types based on whether the duration of the first button press exceeds a length of the finite-length time period, and
interpreting, by at least one computer processor, the third button press type instead of the first and second button press type if at least one processor detects occurrence of a second button press of a button of the plurality of buttons during the finite-length time period.

2. The method of claim 1 wherein each button of the plurality of buttons has a button press value and further comprising determining, by at least one computer processor, a total button press value based on the interpreting between the first, second and third button press types.

3. The method of claim 2 further comprising identifying a character from among a plurality of characters based on the determined total button press value.

4. The method of claim 3 wherein the character is identified by a position in a one-dimensional array corresponding to the determined total button press value.

5. The method of claim 4 further comprising, if the first button press type is interpreted, the at least one computer processor determines the total button press value to be equal to the button press value of the button of the first button press.

6. The method of claim 4 further comprising, if the second button press type is interpreted, the at least one computer processor determines the total button press value to be equal to a multiple of the button press value of the button of the first button press.

7. The method of claim 6 wherein the total button press value equals two times the button press value of the button of the first button press.

8. The method of claim 4 further comprising, if the third button press type is interpreted, the at least one computer processor determines the total button press value to be equal to the sum of the button press value of the button of the first button press and the button press value of the button of the second button press.

9. The method of claim 1 wherein the length of the finite-length time period is selectable by a user.

10. The method of claim 1 wherein the length of the finite-length time period is between 0.05 and 0.2 seconds.

11. A system comprising:
at least one computer processor; and
at least one memory coupled to the at least one computer processor, the at least one memory having computer executable instructions stored thereon that, when executed, cause the at least one processor to perform:
detecting onset of a first button press of a button of a plurality of buttons;
interpreting between first, second and third button press types based on button presses that occur during a finite-length time period measured from the onset of the first button press, the interpreting including:
interpreting between the first and second button press types based on whether the duration of the first button press exceeds a length of the finite-length time period, and
interpreting the third button press type instead of the first and second button press type if at least one processor detects occurrence of a second button press of a button of the plurality of buttons during the finite-length time period.

12. The system of claim 11 wherein each button of the plurality of buttons has a button press value and further comprising determining, by at least one computer processor, a total button press value based on the interpreting between the first, second and third button press types.

13. The system of claim 12 wherein the computer executable instructions, when executed, further cause the at least one processor to perform:
identifying a character from among a plurality of characters based on the determined total button press value.

14. The system of claim 13 wherein the character is identified by a position in a one-dimensional array corresponding to the determined total button press value.

15. The system of claim 14 wherein the computer executable instructions, when executed, further cause the at least one processor to perform:
if the first button press type is interpreted, determining the total button press value to be equal to the button press value of the button of the first button press.

16. A non-transitory computer-readable medium having computer executable instructions stored thereon that, when executed, cause at least one processor to perform:
detecting onset of a first button press of a button of a plurality of buttons;
interpreting between first, second and third button press types based on button presses that occur during a finite-length time period measured from the onset of the first button press, the interpreting including:
interpreting between the first and second button press types based on whether the duration of the first button press exceeds a length of the finite-length time period, and
interpreting the third button press type instead of the first and second button press type if at least one processor detects occurrence of a second button press of a button of the plurality of buttons during the finite-length time period.

17. The computer-readable medium of claim 16 wherein each button of the plurality of buttons has a button press value and further comprising determining, by at least one computer processor, a total button press value based on the interpreting between the first, second and third button press types.

18. The computer-readable medium of claim 17 wherein the computer executable instructions, when executed, further cause the at least one processor to perform:
identifying a character from among a plurality of characters based on the determined total button press value.

19. The computer-readable medium of claim 18 wherein the character is identified by a position in a one-dimensional array corresponding to the determined total button press value.

20. The computer-readable medium of claim 19 wherein the computer executable instructions, when executed, further cause the at least one processor to perform:
if the first button press type is interpreted, determining the total button press value to be equal to the button press value of the button of the first button press.
